(19) United States
(12) Patent Application Publication
(10) Pub. No.: US 2013/0337891 A1
(43) Pub. Date: Dec. 19, 2013

(54) SYSTEM AND METHOD FOR REWARDING USER ACTIVITY OVER A NETWORK

(71) Applicant: Tapgen Corp., Toronto (CA)

(72) Inventors: George Pogostin, Toronto (CA); Steven Braner, Toronto (CA)

(21) Appl. No.: 13/910,642

(22) Filed: Jun. 5, 2013

Related U.S. Application Data
(60) Provisional application No. 61/659,106, filed on Jun. 13, 2012.

(30) Foreign Application Priority Data
Jun. 13, 2012 (CA) 2779805

(51) Int. Cl. A63F 13/12

(52) U.S. Cl. CPC A63F 13/12
USPC 463/25

(57) ABSTRACT

A system and method of rewarding user activity by delivering a contest over a network is provided. The method comprises a contest server disseminating a contest to one or more potential contestants through one or more intermediaries and enabling each of said potential contestants to submit an entry to the contest using at least one of said one or more intermediaries. The contest server enables the selection of a winner of the contest from among said entries; and enables the winner to claim a prize redeemable through a prize distributor selected based on the intermediary through which the entry was submitted.

This application claims the benefit of U.S. Provisional Patent Application Ser. No. 61/659,106 filed Jun. 13, 2012 and Canadian Patent Application No. 2,779,805.

### TECHNICAL FIELD

The following relates generally to delivering contests over a network.

### BACKGROUND

It is well known that contests incentivize consumers to perform a certain task. However, configuring and administering a contest typically is resource intensive and, therefore, many smaller entities forego contests.

Some proposals exist for centrally hosting a contest disseminated through multiple entities. This helps these entities attract consumers to enter the contest, but provides no consumer incentive for repeat business

It is an object of the present invention to mitigate or obviate at least one of the above disadvantages.

### SUMMARY

In one aspect, a method of rewarding user activity by delivering a contest aver a network is provided. The method comprises a contest server disseminating a contest to one or more potential contestants through one or more intermediaries and enabling each of said potential contestants to submit an entry to the contest using at least one of said one or more intermediaries. The contest server enables the selection of a winner of the contest from among said entries; and enables the winner to claim a prize redeemable through a prize distributor selected based on the intermediary through which the entry was submitted.

In another aspect, each of the one or more intermediaries is an application hosted on a mobile device. The mobile device may comprise a contest module. Each of said one or more potential contestants may provide the contest server with contestant information upon entering the contest. The contest server may notify the winner that the winner may claim a prize. The contestant information may comprise a user ID, a device ID, and an application ID.

The prize distributor may be the intermediary used to submit the entry. The winner may be provided with a token to enable the claiming of the prize. Potential contestants may be required to perform one or more requisite tasks prior to entering the contest.

The task may comprise any one of launching a particular application, spending a selected amount of time within an application accessing a particular application a selected number of times over a selected period of time, completing a particular task set out in an application, clicking on an advertisement, providing user information, completing a survey, connecting to a social network, endorsing an item on a social media website, achieving a certain score in a video game, or a combination thereof.

In yet another aspect, a system for rewarding user activity by delivering a contest over a network is provided. The system comprises a contest server operable to disseminate a contest to one or more potential contestants through one or more intermediaries, the potential contestants are each being enabled to submit an entry to the contest using at least one of said one or more intermediaries. The contest server is operable to obtain the selection of a winner of the contest from among said entries. A prize distributor is selected based on the intermediary through which the entry was submitted operable to provide a prize to a user.

In yet another aspect, each of the one or more intermediaries is an application hosted on a mobile device. The mobile device may comprise a contest module. The contest server may be operable to receive contestant information from each one of said one or more potential contestants. The contest server may be operable to notify the winner that the winner may claim a prize. The contestant information may comprise a user ID, a device ID, and an application ID. The prize distributor may be the intermediary used to submit the entry. The contest server may be operable to provide the winner with a token to enable the claiming. The contest module may be operable to verify that the potential contestants each perform one or more requisite tasks prior to submitting an entry.

The task may comprise any one of launching a particular application, spending a selected amount of time within an application, accessing a particular application a selected number of times over a selected period of time, completing a particular task set out in an application, clicking on an advertisement, providing user information, completing a survey, connecting to a social network, endorsing an item on a social media website, achieving a certain score in a video game, or a combination thereof.

### BRIEF DESCRIPTION OF THE DRAWINGS

Embodiments will now be described by was of example only with reference to the appended drawings wherein:

FIG. 1 is a block diagram illustrating an example system for delivering contests;

FIG. 2 is a flow diagram illustrating an example process of a user entering a contest;

FIG. 3 is a flow diagram illustrating example process of a contest server notifying a contest winner;

FIG. 4 is a process flow diagram illustrating an example process of a contest winner redeeming a prize;

FIG. 5 is an example user interface for displaying contests for which a user is eligible to enter;

FIG. 6 is an example user interface for entering a contest; and

FIG. 7 is an example user interface for confirming identity after winning a contest.

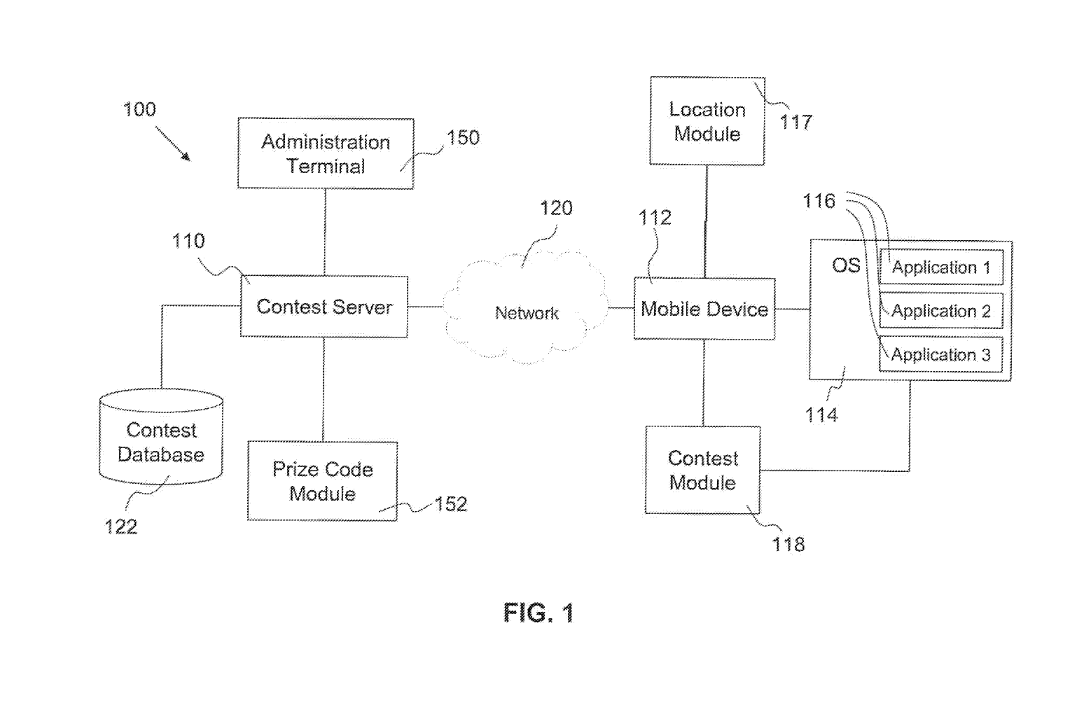

### DETAILED DESCRIPTION OF THE DRAWINGS

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any module, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media.

It will also be appreciated that the examples and corresponding diagrams used herein are for illustrative purposes only. A person of skill in the art will appreciate that different configurations and terminology can be used without departing from the principles expressed herein. For example, components and modules can be added, deleted, modified, or arranged with differing connections without departing from these principles.

A system and method are provided for rewarding user activity over a network. In one aspect, the system enables a user to enter a contest through an intermediary. For example, the intermediary may comprise an application on a mobile device. A user that has entered a contest may be referred to as a contestant. The contest is administered by a contest server that may be in communication with the mobile device over a network. The mobile device enables the user to enter personal information or contact information which may be provided to the contest server, as is further described below.

In another aspect, the system enables a contest administrator to disseminate a contest through a plurality of intermediary applications. Contestants and potential contestants may view or enter the contest through the plurality of intermediary applications but may only retrieve a prize by performing a task determined by the intermediary application linked to the awarding of the prize and only from a single selected application. For example, the contest may be disseminated through a plurality of applications on, or available to, a mobile device. However, a winning contestant may only retrieve a prize from a single selected application.

In yet another aspect, the system enables a contest administrator to reward or incentivise the completion of a task by a contestant or a potential contestant. By rewarding a contestant or potential contestant for completing a selected task, the contest administrator may encourage that task. For example, the administrator may enable users who perform a predetermined task on a regular basis to register for multiple entries into a contest. The selected task may include launching a particular application, spending a selected amount of time within the application, accessing a particular application a selected number of times over a selected period of time, completing a particular task set out in the application, clicking on an advertisement, providing user information, completing a survey, connecting to a social network, endorsing an item on a social media website, achieving a certain score in a video game completing a game on a mobile device, etc.

The task may also be time-based. For example, a user may be allowed to enter a contest after spending 5 minutes in an application. Alternatively, or in addition, a user may be awarded one entry for every selected period of time that the user runs, or interacts with, the application. For example, the user may be awarded one entry per minute of interaction with the application.

The task may also be a task that is not performed directly on the mobile device but may be confirmed by the mobile device. For example, the task may be to reach a particular location to enter a contest. Upon the user reaching the selected location, a contest module may enable the user to enter the contest or may automatically enter the user in the contest. The prize may be redeemed as described further herein.

In yet another aspect, a system is provided to enable a user to access contest information within an application on a mobile device. The system may be operable to selectively display or otherwise indicate contests to which a user is eligible to enter. The system further enables a user to provide contestant information to the mobile device, which may be further provided to a contest server as will be described below.

The contest may be a lottery, a bet, a draw, a raffle, a game of chance, a pool, a sweepstake, a wager, or any other form of contest that may be implemented through the functionality as described below.

Turning now to FIG, 1, a contest delivery system 100 for delivering a contest to a user is provided. The contest delivery system 100 comprises a mobile device 112. The mobile device 112 comprises, or is linked to, a processor and a memory operable to store computer executable instructions which, when executed by the processor, implement the functionality described herein. The mobile device 112 may comprise instructions for implementing an operating system 114. The mobile device 112 comprises one or more applications 116 which may be in communication with the operating system 114. The mobile device 112 further comprises, or is linked to, a contest module 118. The contest module 118 may further be in communication with the operating system 112 or the one or more applications 116 on the mobile device 112. The mobile device 112 may also comprise a location module 117 operable to obtain location information. The location module 117 may comprise, or be linked to, a GPS receiver, a wireless network connection, or other sensors that may be used to determine the location of the mobile device 112.

The mobile device 112 may be a smartphone, a laptop, a tablet, an mp3 player comprising a network connection, or any other network enabled mobile device. It will be appreciated that although examples are provided in the context of a mobile device, the principles discussed herein are equally applicable to other communication devices, for example, desktop computers, kiosks, communication systems in vehicles, etc.

The mobile device 112 is in communication with a contest server 110 over a network 120. The network 120 may be a wired network or a wireless network, for example, a cellular network or a Wi-Fi network. The contest server 110 comprises, or is in communication with a contest database 122. The contest server is operable to store and retrieve contestant and contest information in the contest database 122.

Contest information may comprise the contest name, beginning and end dates of the contest, eligibility requirements, prize, terms and conditions of the contest, information required of contestants and contest entry conditions. The contestant information may include a contestant identifier, for example, the contestant's name, the date that the contestant entered the contest, the number of entries attributed to the contestant, tasks that the contestant has completed, and the contestant's personal information.

The contest module 118 may be operable to obtain contestant information from the user of the mobile device 112 and provide the contestant information to the contest server 110 over the network 120. The contest module 118 may also be operable to obtain contest information from the contest server 110 and provide the contest information to each of the applications 116 on the mobile device 112. The contest module 118 enables a user to access contest information from within one or more of the applications 116. The contest module 118 is also operable to obtain contest information from the contest server 110 and provide the contest information to a user through one or more applications 116. Similarly, the contest module 118 enables a user to enter a contest through one or more of the applications, as will be further described herein.

The contest delivery system 100 may further comprise an administration terminal 150 in communication with the contest server 110, the administration terminal being operable to provide new contests to the contest server 110 or to modify existing contests being hosted by the contest server 110.

The system 100 may also comprise a prize code module 152, operable to generate a token comprising, for example, a prize claim code that may be associated with the contest information. The token may also comprise a bar code, an alphanumeric code, a numeric code, or other code comprising a contest identifier.

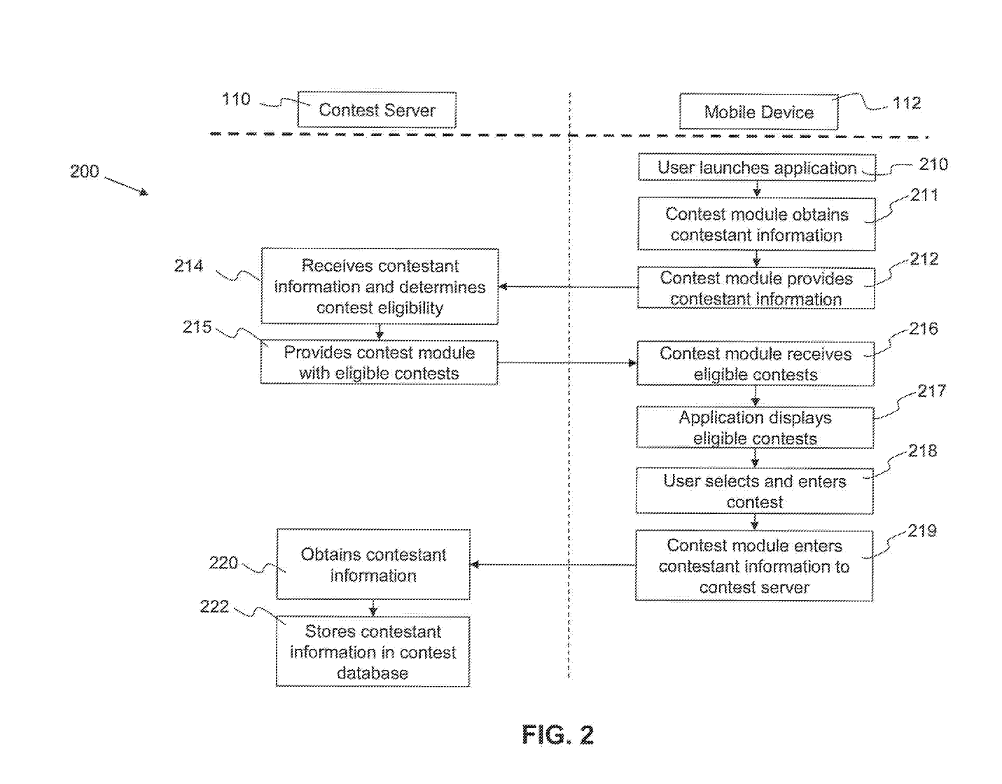

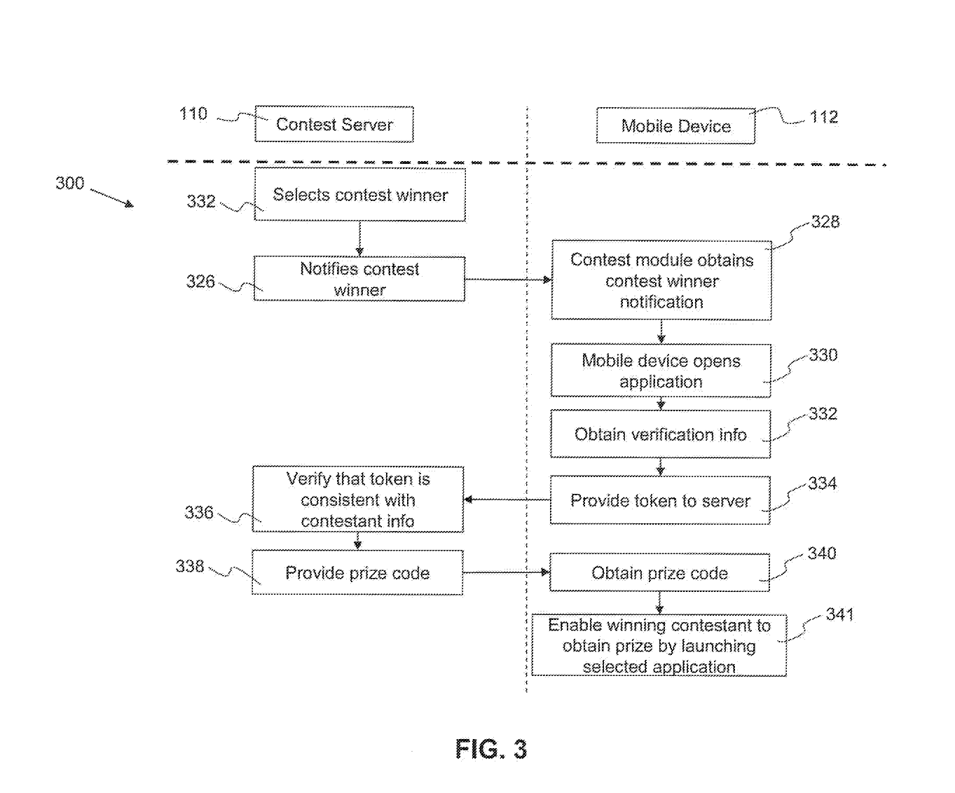

Referring now to FIG. 2 and FIG. 3, a process for entering a contest 200 and 300 is provided. Specifically, in FIG. 2, a process of a user entering a contest is provided and in FIG. 3, an example process of a contest server 110 determining the winner of a contest and delivering a prize to the winner is provided.

In step 210 of FIG. 2, a user launches an application 116 on the mobile device 112. The application 116 may be, launched through the operating system 114 of the mobile device 112.

In step 211 the contest module 118 obtains contestant information. The contestant information may comprise a user ID, device ID and an application ID. The contestant information may also comprise personal information relating to the user, device information, application information, time and date information, or other information relevant to advertising or contest administration. The contestant information may be provided by the user or may be automatically obtained by the contest module 118.

In step 212, the contest module 118 provides the contestant information to the contest server 110. Upon the contest server 110 receiving the contestant information, the contest server 110 determines which contests the potential contestant is eligible to enter in step 214. In step 215, the contest server 110 provides the contest module 118 with a list of contests for which the potential contestant is eligible to enter. For example, the list may comprise contests for the potential contestant's age group, geographic region, or location. The list may be automatically updated as the user information changes. For example, if the user's location changes, the list may update to reflect the change. For example, if a user enters a shopping centre, or is sufficiently close to the shopping centre, the location module 117 may provide the updated location information to the contest module 118. Upon receiving the updated location information, the contest module 118 may obtain an updated list of contests comprising contests relevant to the location of the mobile device 112, such as contests relating to stores in the shopping centre. The list may comprise information relating to each of the contests, as will be further described below. The contest module 18 receives the list of eligible contests and associated information in step 216.

In step 217, the contest module 118 may display contest information in the application 116 for all contests, or for all contests in which the user of the mobile device 112 is eligible. The contest module 118 may display the contest information automatically, or upon a user's request, for example, by selecting a contest command. Upon the user selecting a contest in step 218, the mobile device 112 may request the user to provide further personal information to enter with the contestant information. This personal information may be obtained by the contest module 118 and provided to the contest server as contest information in step 219. The contest server then obtains the contestant information in step 220. The user information may also comprise information regarding the mobile device 112.

Alternatively, the mobile device 112 may have the mobile device user's information, for example, through an application 116 or through sign-in information in the device 112. By way of example, the sign-in information may comprise an e-mail address and password or a social media identity. If the user signs on to an account associated with existing user identity, the contest module 118 may automatically obtain the contestant's information and provide this information to the contest server 110. The user may be provided with a notification that the user has entered as a contestant for the selected contest.

In step 222, the contest server 110 stores the contestant information obtained from the contest module 118 in the contest database 122. The contestant information may comprise a user ID, device ID and an application ID. For example, the device ID may comprise a personal identification number (PIN), an e-mail address, a telephone number, etc. The contest information may alternatively comprise only a user ID and an application ID. The contestant information may also comprise the contestant's name, e-mail address, age, and location. If the contestant is given an option to select a prize or potential prize from two or more alternatives, the user's prize may be selected. The contestant information may also be retrieved from the contest database 122 if the user has previously entered contests or has otherwise previously provided use information to the contest database 122.

Turning now to FIG. 3, the process of a contest server 110 delivering a prize to a user is provided. The contest server 110 may select a winner 322 or obtain winner information from the administrator terminal 150. The contest server 110 may select the winner by any prize-selecting algorithm. Upon obtaining winner information in step 322, the contest server 110 determines the device ID associated with the contest winner's contest information and provides a notification to the contest module 118 on the mobile device 112 linked to the winning contestant in step 326. The notification may comprise an application ID corresponding to the application 116 that the user must use to obtain the prize. The notification may be provided through various media, for example, in an e-mail or a text message. In step 328, the contest module 118 of the mobile device 112 linked to the winner of the contest obtains the winner notification. The contest module 118 may then automatically, or upon the user's command, launch a selected application 116. The selected application 116 may be a specialized prize distribution intermediary or may be the application that was used by the user when entering the contest to be determined by the application ID in step 330. The specialized prize distribution intermediary may be referred to as a prize distributor.

The mobile device 112 may otherwise provide an indication to the user of the mobile device 112 to launch the application 116, such as by using a pop-up alert which may be provided via the operating system 114. Alternatively, the mobile device 112 may not provide any active indication to the user, requiring that the user periodically check the application 116 to determine if the user has been selected as a winner of a prize.

In step 332, the contest module 118 verifies the user's identity. The contest module 118 may verify the user's identity by requesting a username and password combination, an e-mail address and password combination, or other personal information. Upon verifying the identity of the user, the contest module 118 provides a token comprising verification information to the contest server in step 334. The contest server then verifies that the verification information is consistent with the contestant information of the contest winner stored in the contest database 122 in step 336. If the verification information is not consistent with the contestant information of the winner, no prize is awarded. However, if the verification information is consistent with the contestant information of the contest winner on the contest database 122, the contest server 110 provides a prize code 338 to the contest module 118 on the mobile device 120.

The token may further comprise other information tram the winner, for example, a message or file in reaction to winning a prize. By way of example, the message may include the winner's initial reaction to having won the contest. The winner's reaction may be used to encourage potential contestants to enter contests. The prize code may be generated by the prize code module 152. The prize may be a gift certificate, in which case, the prize code may be used as a proof of possession of the gift certificate.

In step 340, the contest module 118 on the mobile device 112 obtains the prize code. In step 341, the contest module 118 enables the winning contestant to obtain the prize code by launching a selected application. As outlined above, in an example embodiment, the selected application is a specialized application 116 for distributing prizes to winning contestants. The specialized prize distribution application may enable users to claim a prize. The specialized prize distribution application may otherwise, or in addition, distribute prize codes associated with the prize. In another example embodiment, the selected application is any application. In another example embodiment, the selected application is the application that the contestant had used to enter the contest. In yet another embodiment, the selected application is chosen based on the applications 116 installed on, or available to, the mobile device 112. For example, the selected application may be the least used application 116 on the mobile device 112 to encourage use of that particular application 116. It will be appreciated that the selected application may be selected based on various other criteria.

The contest module 118 may deliver the prize code to the user via e-mail, via displaying the prize code to the user, or providing the prize code within a selected application. For example, the contest module 118 may deliver the prize code through a specialized application for distributing contest prizes. The contest module 118 may otherwise deliver the prize code through the application that the contestant had used to enter the contest.

The contest server 110 may optionally notify the user, for example, via e-mail, that the user has won the contest. The notification may comprise prize information, a confirmation number, information relating to the application 116 that the user had used to enter the contest, information relating to the application 116 where the prize may be obtained, a link to the application where the prize may be obtained, instructions to claim the prize, and any other information relevant to the prize, advertising, or the contest. The e-mail may optionally comprise a prize. The contest module 118 may enable a user to claim a prize through any selected application 116. For example, a user may enter a contest through application A. In one embodiment, the contest module 118 may notify the winner through application B or provide the winner with the prize code through application B. By way of example, the contest module 118 may notify the user that the user must launch a particular application 116. Upon launching the application, the contest module 118 may display the prize code to the user. The contest module 118 may further request that the winner perform one or more tasks to retrieve the prize code, for example, click on an ad or validate the winner's identity.

The contest module 118 on the mobile device may be operable to verify that the user has completed the task required to enter the contest. Alternatively, the user may be provided with a task completion token, for example, an alphanumeric code, a reference number, a bar code, etc. upon completion of the task. The contest module 118 may be operable to obtain the task completion token from the user to verify that the user has completed the task. Upon verifying that the user has completed the requisite task or tasks for a contest, the contest module 118 may provide contestant information to the contest server 110 to enter the user as a contestant. Alternatively, the contest module 118 may notify the user that the user is eligible to enter a contest after completing the one or more requisite tasks, such that the user could then enter the contest through an application 116.

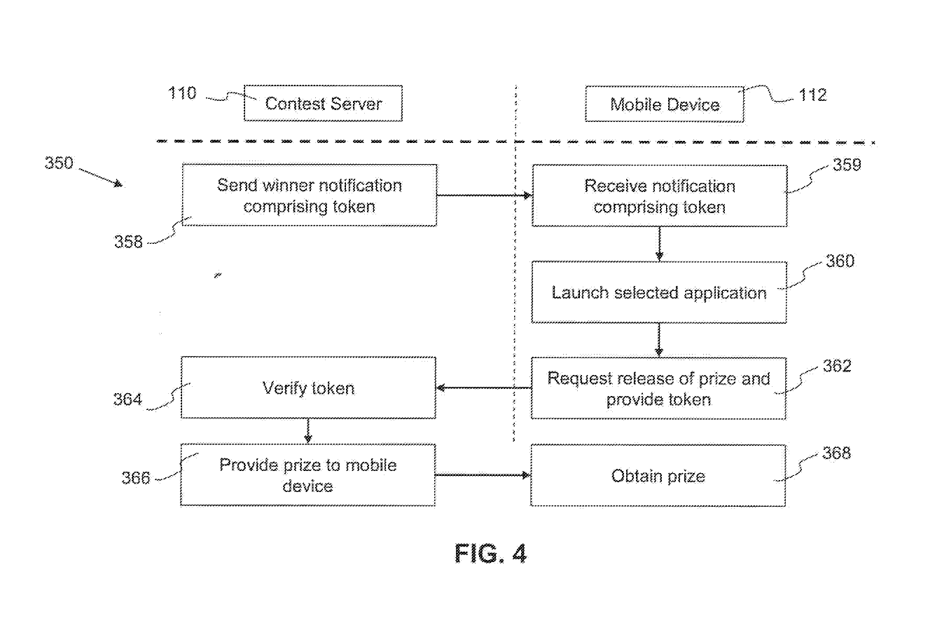

Turning now to FIG. 4, a process flow diagram for a contest winner redeeming an award is provided. For example, the process flow diagram of FIG. 4 may be used in an embodiment wherein the prize is redeemed from an application different to the one used to enter the contest. In step 358, the contest server 110 provides a notification to the contest module 118 of the mobile device 112 that the user of the mobile device 112 is a winner. The notification may comprise a token, for example, a claim code. The contest module 118 receives the notification comprising a token in step 369. In step 360, the contest module 118 on the mobile device 112 enables a user to launch a selected application 116. The contest module 118 may use the application ID obtained from the contestant information to identify the application 116 to be launched. In step 362, the winning contestant requests release of the claimed prize and provides the token to the contest server 110. In step 364, the contest server 110 verifies the token and, in step 366, provides the prize to the mobile device 112 and in step 368, the mobile device 112 obtains the prize 368. The user may then have access to the prize on the mobile device 112. The prize may comprise a gift certificate, coupon code, electronic funds transfer, etc.

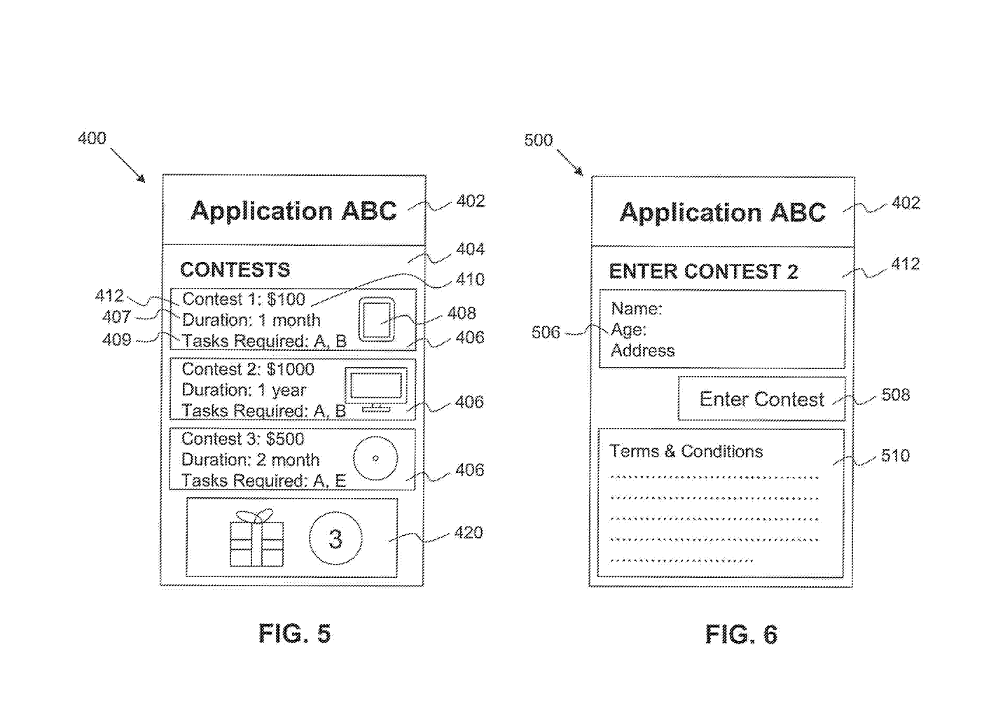

Referring to FIG. 5, a user interface for displaying a list of contests 400 to a user is provided. The interface may comprise the name of the application in which the list of contests is being displayed 402. The interface may further comprise a title 404 indicating the relevance of each of the contests displayed. For example, the title may indicate that the contests displayed are all contests for which the user is eligible to enter. Alternatively, the title may indicate that the user may not be eligible to enter one or more of the contests being displayed.

One or more contests may be provided 406, each of which may comprise a contest name 412, a duration 407, a prize 408, tasks required to enter the contest, and the value of the prize 410. The interface may display several contests. The user may have the option to filter which contests are displayed. The user may further have the option to remove contests from the display or select contests that the user wishes to enter. It will be appreciated that the mobile device 112 may further enable the user to perform other functions with regards to the contest list, for example, the mobile device 112 may enable a user to select a particular contest to view further information regarding that contest.

The user interface 400 may also display an icon 420 that indicates the number of active contests in which the user is a contestant, it will be appreciated that other icons and information may be displayed to the user including the number of contests that the user has entered, the number of contests that the user has won, or the number of contests that the user's contacts have entered or won. The user interface 400 may also display further actions that the user may take to increase the user's odds of winning the contest. For example, the interface 400 may display to the user an indication that if the user wishes to submit another entry to a particular contest, the user must view a selected advertisement or perform another type of action, for example, download an application 116.

The content delivered through the applications 116 may be web-based, enabling the contest server 110 and/or the administration terminal 150 to dynamically update content and the styling of contests. The web based nature of the content enables the content to be displayed across a variety of types of mobile devices 112 and a variety of applications 116. The administrator of any application 116 may decide to host a contest through the contest delivery system in order to garner attention for the application 116, increase the user-base of the application 116, provide an incentive for users to perform a particular action in relation to the application, or increase the amount of time that users spend in the application 116 in order to increase user retention.

Upon the user selecting a particular contest, the mobile device may enable a user to enter the contest. Referring to FIG. 6, a user interface providing further information regarding a user selected contest 500 is provided. Similarly to the interface shown in FIG. 5, the interface may comprise an indication of the application through which the contest is being viewed 402. The user interface may also comprise a title indicating the contest that the user is viewing 412. In addition to the contest name 412, contest duration 407, prize 408, and economic value of the prize 410, the user interface 500 may display information comprising terms and conditions of the contest or other relevant details 510.

The interface may comprise input fields 506 in which a user can enter personal information, confirm personal information, or provide other details such as location and desired prize type. The contest module 11 obtains the user's personal information and provides this personal information to the contest server 110 as described above. The users personal information may be obtained by the contest module 118 if the user has signed into an account on the mobile device 112.

The user interface 500 may further provide the user an option to enter the contest 508. The option may be provided as a command, for example, a button, a toggle, or through other means. By entering the contest, the user may agree to the terms and conditions outlined in the information field 610, at which point the contest module 118 may provide the contest server with a contest entry in the name of the user of the mobile device 112.

At the end of a contest, a prize may be awarded. The contest sewer 110, may select the winner from the contest database 122 as described above or receive winner information from the administrator terminal 150. Upon the contest server 110 identifying the contest winner, the application server may notify the contest winner via the mobile device 112 over the network 120. The contest module 110 may notify the winner via text message, e-mail, a push notification in an application, etc. The winning contestant may be required to launch the application 116 that the contestant had originally used to enter the contest or any other selected application. The contest module 110 may also provide the contest module 118 a notification that the user has won a contest and the contest module 118 may notify the user of the mobile device 112 upon the user launching an application 116. Alternatively, a contest administrator 150 may be notified and the contest administrator may notify the winning contestant.

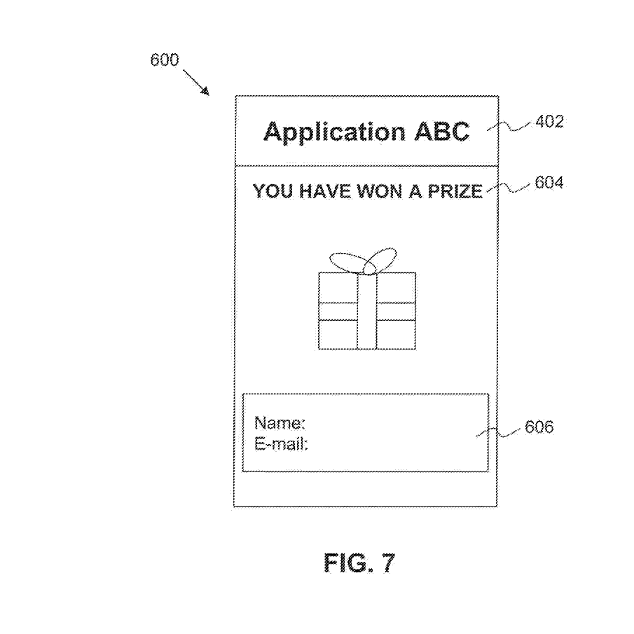

Referring to FIG. 7, a user interface 600 for notifying a winning contestant that the contestant has won a prize is provided. The interface 600 may be provided to a user upon the user launching the application 118 through which the user had originally entered the contest. The interface 600 may also be provided through another selected application 116 or through the operating system 114. The interface may comprise the title of an application 402 and a message indicating to the user that the user has won a prize 604. The user interface may further comprise an input for the user to input verification information 606. As outlined above, the verification may comprise a username and password combination or an e-mall and password combination. The user interface may also provide the user with further information or actions that the user must perform to obtain a prize, for example, answer a skill testing question.

Upon the user providing verification information in the user interface 600, the contest module 118 provides the verification information to the contest server 110. The contest server, upon determining that the verification information is consistent with the winning contestant's information, may send the user a prize. The prize may be, for example, in the form of a gift card or a code enabling a user to redeem a particular good or service from an online or retail source. The prize may also comprise credits that may be used to purchase applications 16 or used for in-application purchases.

Any one of interfaces 400, 500, and 600 shown in FIGS. 4, 5, and 6 may be provided to a user through several applications. This is advantageous since the same contest may be delivered to users of various applications. Moreover, the particular applications through which the contest is administered may be selected by the contest server 110 or by an administrator at the administrator terminal 150. The administrator terminal 150 may be operable to enable a contest administrator to select the contest type, duration, prize, assign a value to the prize, associate, a contest with an application. For example, a contest may be delivered to all users of a Facebook™ application, a LinkedIn™ application and a news application, for example, the New York Times™. Contests, may further be targeted based on specific user information, for example, information obtained from a user's social media account. By way of example, users of a certain age group may be targeted.

The administrator terminal 150 may comprise a personal computer or mobile device operable by the administrator comprising a software development kit (SDK). The SDK comprises computer executable instructions that enable the administrator terminal 150 to enable the aforementioned tasks.

It can be appreciated that the information provided to contestants and potential contestants may depend on the geographic location or region in which the contestants are located. For example, in Canada, contestants may be required to answer a skill-testing question whereas in other jurisdictions, a skill-testing question is not required.

Any comments made by contestants or potential contestants, and in particular, by the contest winner may be captured by the contest module 118 and provided to the contest server 110. The contest server 110 may than publish comments made by the contestants. The comments may comprise, for example, messages posted on social media.

The contest server 110 may be operable to generate a unique identifier for each contestant. The contestant identifier may be used by a friend of the contestant in which case the contestant may receive a referral bonus, for example, as an additional contest entry. A user may accumulate bonuses for performing other tasks, for example, for clicking ads, referring friends, making posts on a social media website, endorsing an item on a social website (e.g. using the Facebook™ like” button), or using an application. Bonuses may be used to obtain additional entries for contests.

It will also be appreciated that the mobile device 112 is operable to display ads at any time during the contest. For example, the mobile device 112 may display an ad within an application 116 as a user is registering for a contest, after the user has registered for a contest, as a user is verifying whether the user has won a contest, after the user has won the contest, or at any other time.

We claim:

1. A method of rewarding user activity by delivering a contest over a network, the method comprising:
a) a contest server disseminating a contest to one or more potential contestants through one or more intermediaries;
b) enabling each of said potential contestants to submit an entry to the contest using at least one of said one or more intermediaries;
c) enabling the selection of a winner of the contest from among said entries; and
d) enabling the winner to claim a prize redeemable through a prize distributor selected based on the intermediary through which the entry was submitted.

2. The method of claim 1, wherein each of the one or more intermediaries is an application hosted on a mobile device.

3. The method of claim 2, wherein the device comprises a contest module.

4. The method of claim 1, wherein each of said one or more potential contestants provides the contest server with contestant information upon entering the contest.

5. The method of claim 1, further comprising the contest server notifying the winner that the winner may claim a prize.

6. The method of claim 4, wherein the contestant information comprises a user ID, a device ID, and an application ID.

7. The method of claim 1, wherein the prize distributor is the intermediary used to submit the entry.

8. The method of claim 3, further comprising providing the winner with a token to enable the claiming.

9. The method of claim 1, further comprising the step of requiring potential contestants to perform one or more requisite tasks prior to step (b).

10. The method of claim 9, wherein the task comprises any one of launching a particular application, spending a selected amount of time within an application, accessing a particular application a selected number of times over a selected period of time, completing a particular task set out in an application, clicking on an advertisement, providing user information, completing a survey, connecting to a social network, endorsing an item on a social media website, achieving a certain score in a video game, or a combination thereof.

11. A system for rewarding user activity by delivering a contest over a network, the system comprising:
a) a contest server operable to disseminate a contest to one or more potential contestants through one or more intermediaries;
b) the potential contestants are each being enabled to submit an entry to the contest using at least one of said one or more intermediaries;
c) the contest server further being operable to obtain the selection of a winner of the contest from among said entries; and
d) a prize distributor selected based on the intermediary through which the entry was submitted operable to provide a prize to a user.

12. The system of claim 11, wherein each of the one or more intermediaries is an application hosted on a mobile device.

13. The system of claim 12, wherein the mobile device comprises a contest module.

14. The system of claim 11, wherein the contest server is operable to receive contestant information from each one of said one or more potential contestants.

15. The system of claim 11, wherein the contest server is operable to notify the winner that the winner may claim a prize.

16. The system of claim 14, wherein the contestant information comprises a user ID, a device ID, and an application ID.

17. The system of claim 11, wherein the prize distributor is the intermediary used to submit the entry.

18. The system of claim 13, wherein the contest server is operable to provide the winner with a token to enable the claiming.

19. The system of claim 11, wherein the contest module is operable to verify that the potential contestants each perform one or more requisite tasks prior to submitting an entry.

20. The system of claim 19, wherein the task comprises any one of launching a particular application, spending a selected amount of time within an application, accessing a particular application a selected number of times over a selected period of time, completing a particular task set out in an application, clicking on an advertisement, providing user information, completing a survey, connecting to a social network, endorsing an item on a social media website, achieving a certain score in a video game, or a combination thereof.
